(19) United States
(12) Patent Application Publication
(10) Pub. No.: US 2011/0115300 A1
(43) Pub. Date: May 19, 2011

(54) CONVERTING DEVICE WITH MULTIPLE INPUT TERMINALS AND TWO OUTPUT TERMINALS AND PHOTOVOLTAIC SYSTEM EMPLOYING THE SAME

(75) Inventors: Huo-Hsien CHIANG, Taipei City (TW); Chiou Fu WANG, Yonghe City (TW)

(73) Assignee: DU PONT APOLLO Ltd., Hong Kong (HK)

(21) Appl. No.: 12/915,926

(22) Filed: Oct. 29, 2010

Related U.S. Application Data
(60) Provisional application No. 61/262,383, filed on Nov. 18, 2009.

(51) Int. Cl. H02M 7/42

(52) U.S. Cl. 307/82

(57) ABSTRACT

A converting device with multiple input terminals and two output terminals is disclosed for converting Direct Current (DC) power from a power source to Alternating Current (AC) power. The converting device includes N pairs of input electrodes (N is an integer and N≧2), configured to receive the DC power from the power source, N maximum power point trackers, each coupled to one pair of the N pairs of input electrodes, configured to track a maximum power operation point for the DC power received from the one pair of the N pairs of input electrodes, two DC/DC converters, each coupled to one of the N maximum power point trackers, configured to convert a DC voltage received from the one of the N maximum power point trackers, a DC/AC inverter, coupled to the N DC/DC converters, configured to convert N DC voltages provided by the N DC/DC converters to an AC output signal, and a controller, coupled to the N DC/DC converters and the DC/AC inverter, configured to control the DC/DC conversion operation of the N DC/DC converters and the DC/AC conversion operation of the DC/AC inverter.

### Field of the Invention

The invention relates generally to a converting device and photovoltaic system and, more particularly, to a converting device with multiple input terminals and two output terminals that can convert DC power from a three-terminal, four-terminal or multiple-terminal photovoltaic module to AC power, and a photovoltaic system employing the same.

### BACKGROUND OF THE INVENTION

Environmental concerns and the search for alternative sources of energy relative to fossil fuel energy sources have driven the need for photovoltaic systems, which can process sunlight into electric power for supplying households or small commercial sites.

Conventional photovoltaic power systems typically include a plurality of interconnected photovoltaic modules, which are often referred to as an array, and one or more inverters coupled to the photovoltaic modules to convert DC power from the photovoltaic modules to AC power. As production of solar energy becomes competitive in costs and efficiency, it is likely that solar energy will be used more widely. Therefore, great efforts have been put on improving the overall power efficiency and reducing the costs for photovoltaic power systems.

One way to improve power efficiency of photovoltaic modules is by stacking two photovoltaic devices with different absorption energy edges, i.e., to form the so-called multi-junctions (MJs) PV photovoltaic. However, this method not only leads to complex fabrication and hence high costs but also causes difficulty that the currents generated by the two photovoltaic devices have to be matched under all operation conditions for a two-terminal MJs photovoltaic module.

Another way (for example, see US publication No. 2005/0,150,542A1) was then proposed, which provides a three-terminal or four-terminal photovoltaic module released from the current-matching constrains in the MJs photovoltaic module proposed by the first way. The three-terminal or four-terminal photovoltaic module is formed by mechanically integrated two photovoltaic devices, one on top of the other, where each photovoltaic device has two individual output electrodes that can be connected externally. That is, the whole photovoltaic module has two pairs of output electrodes from each constituent photovoltaic device. However, to utilize the DC power provided by the three-terminal or four-terminal photovoltaic module, the DC power provided by one pair of output electrodes and the DC power provided by the other pair of output electrodes have to be combined before being provided to a load (e.g., a power grid). Consequently, the photovoltaic system complexity and manufacturing costs both increase due to extra wirings for the one or two extra terminal.

### SUMMARY OF THE INVENTION

In view of above, a converting device with multiple input terminals and two output terminals is provided which can be coupled to a three-terminal, four-terminal or multiple-terminal photovoltaic module for the higher power efficiency brought by the photovoltaic module, while having reduced complexity and wiring and manufacturing costs. Additionally, a photovoltaic system employing such a converter is also provided.

In one aspect, a converting device with multiple input terminals and two output terminals is provided for converting Direct Current (DC) power from a power source into

Alternating Current (AC) power. The converting device includes N pairs of input electrodes (N is an integer and N≧2), configured to receive the DC power from the power source, N maximum power point trackers, each coupled to one pair of the N pairs of input electrodes, configured to track a maximum power operation point for the DC power received from the one pair of the N pairs of input electrodes, N DC/DC converters, each coupled to one of the N maximum power point trackers, configured to convert a DC voltage received from the one of the N maximum power point trackers, a DC/AC inverter, coupled to the N DC/DC converters, configured to convert N DC voltages provided by the N DC/DC converters into an AC output signal, and a controller, coupled to the N DC/DC converters and the DC/AC inverter, configured to control the DC/DC conversion operation of the N DC/DC converters and the DC/AC conversion operation of the DC/AC inverter.

In another aspect, a photovoltaic system is provided, comprising one or more power sources for converting solar energy to DC power, and one or more converting device for converting the DC power output from the one or more power sources to AC power for output from the photovoltaic system. Each of the converting device comprises N pairs of input electrodes, configured to receive the DC power from the one or more power sources, N maximum power point trackers, each coupled to one pair of the N pairs of input electrodes, configured to track a maximum power operation point for the DC power received from the one pair of the N pairs of input electrodes, N DC/DC converters, each coupled to one of the two maximum power point trackers, configured to convert a DC voltage received from the one of the N maximum power point trackers, a DC/AC inverter, coupled to the N DC/DC converters, configured to convert N DC voltages provided by the N DC/DC converters into an AC output signal, and a controller, configured to control the DC/DC conversion operation of the N DC/DC converters and the DC/AC conversion operation of the DC/AC inverter.

In further another aspect, a power converting method is provided for converting

DC power to Alternating Current (AC) power. The method comprises tracking N maximum power operation points for the DC power and providing N first DC voltages, converting the N first DC voltages into N second DC voltages, respectively, and converting the N second DC voltages into an AC output signal.

These and other features, aspects, and embodiments are described below in the section entitled “Detailed Description of the Invention.”

### BRIEF DESCRIPTION OF THE DRAWING

Features, aspects, and embodiments are described in conjunction with the attached drawings, in which:

FIG. 1 is a schematic diagram illustrating the architecture of a converter in accordance with a first embodiment;

FIG. 2 is a schematic diagram illustrating the architecture of a converter in accordance with a second embodiment; and

FIG. 3 is a schematic diagram illustrating the architecture of a converter in accordance with a third embodiment.

### DETAILED DESCRIPTION OF THE INVENTION

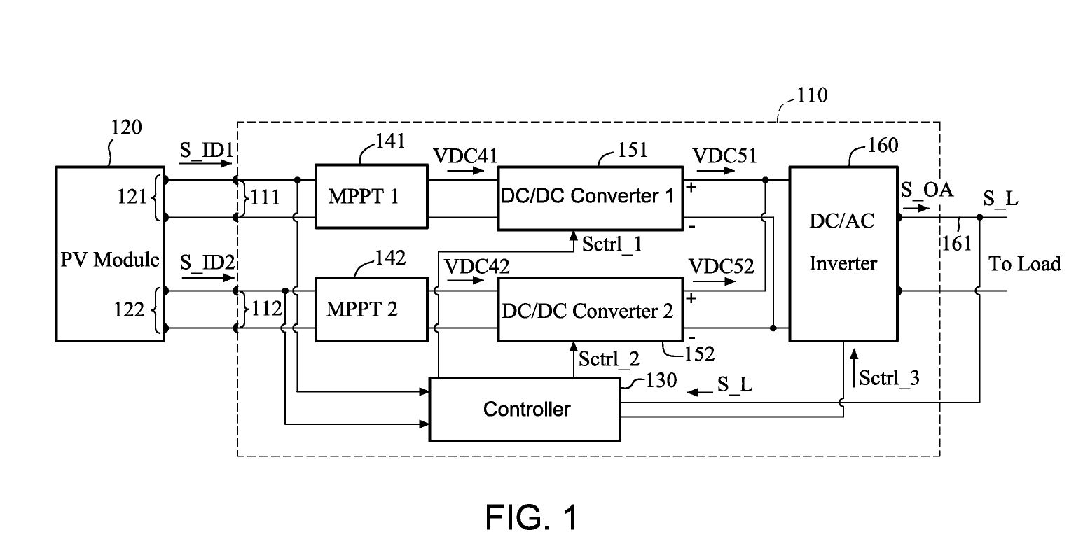

FIG. 1 is a schematic diagram illustrating the architecture of a converter 110 in accordance with a first embodiment, which can convert DC (Direct Current) power from a power source (in the exemplary embodiment, a four-terminal photovoltaic module (PV module) 120) into AC (Alternating Current) power that can be fed to a load such as a power grid (not shown).

As shown, the PV module 120 has four output terminals grouped as two pairs of output electrodes 121 and 122. Correspondingly, the converter 110 includes four input terminals grouped as two pairs of input electrodes 111 and 112, which can be coupled to the pairs of output electrodes 121 and 122, respectively. The converter 110 can receive two DC input signals S_ID1 and S_ID2 respectively at the two pairs of input electrodes 111 and 112 from the PV module 120, and then converts the received DC input signals S_ID1 and S_ID2 into a single AC output signal S_OA.

Additionally, the converter 110 further includes a controller 130, two maximum power point trackers (MPPTs) 141 and 142, two DC/DC converters 151 and 152, and a DC/AC inverter 160.

The MPPTs 141 and 142 are configured to track maximum power operation points for the DC output power of the four-terminal PV module 120, so as to maximize the DC power transferred from the four-terminal PV module 120 to the load. Specifically, the MPPTs 141 and 142 are coupled to the corresponding pairs of input electrodes 111 and 112, respectively, so as to extract the maximum power operation points based on respective I-V curves of the corresponding DC input signals S_ID1 and S_ID2, respectively. As such, the DC power generated by the four-terminal PV module 120 can be efficiently provided to the load under various environmental conditions.

The DC/DC converters 151 and 152 are configured to convert two DC voltages VDC41 and VDC42 respectively received from the MPPTs 141 and 142 to other two DC voltages VDC51 and VDC52 in accordance with the control of the controller 130. Preferably, the values of the two DC voltages VDC51 and VDC52 generated by the DC/DC converters 151 and 152 are both equal to a predetermined value. The predetermined value is the optimal input operating voltage value of the DC/AC inverter 160.

More specifically, the DC/DC converters 151 and 152 are connected to the corresponding MPPTs 141 and 142 to receive the two DC voltages VDC41 and VDC42, respectively. Additionally, the DC/DC converters 151 and 152 are further used to receive first and second controlling signals Sctrl_1 and Sctrl_2, respectively, from the controller 130. Based on the first controlling signal Sctrl_1 that indicates a first voltage conversion ratio defined as VDC51/VDC41, the DC/DC converter 151 can convert the DC voltage VDC41 to the DC voltage VDC51 equal to the predetermined value. Similarly, based on the second controlling signal Sctrl_2 that indicates a second voltage conversion ratio defined as VDC52/VDC42, the DC/DC converter 152 can convert the DC voltage VDC42 to the DC voltage VDC52 equal to the predetermined value.

Furthermore, the two DC/DC converters 151 and 152 are parallel-connected to the DC/AC inverter 160. The DC/AC inverter 160 is configured to convert the DC voltages VDC51 and VDC52 provided by the DC/DC converters 151 and 152 into the AC output signal S_OA, which can then be coupled to the load. Additionally, the DC/AC inverter 160 performs the DC to AC conversion in accordance with the control of the controller 130 so as to maintain phase synchronicity with an AC line signal S_L on an external AC line 161 coupled to the load. In other words, the DC/AC inverter 160 is controlled by the controller 130 to ensure that the AC output signal S_OA is synchronously output to match the phase of the AC line signal S_L.

The controller 130 is configured to compute the first and second voltage conversion ratios, so as to transmit the controlling signals to the two DC/DC converters 151 and 152. Specifically speaking, in accordance with a preferred embodiment, the controller 130 receives the two DC input signals S_ID1 and S_ID2 and then compute the first voltage conversion ratio according to the DC input signals S_ID1 voltage value and the predetermined value, and computes the second voltage conversion ratio according to the DC input signal S_ID2 voltage value and the predetermined value. As such, the controller 130 then generates the first and second controlling signals Sctrl_1 and Sctrl_2 respectively indicating the first and second voltage conversion ratios, and then transmits the first and second controlling signals Sctrl_1 and Sctrl_2 respectively to the DC/DC converters 151 and 152.

Additionally, the controller 130 also controls the DC/AC inverter 160 such that the DC/AC inverter 160 can be phase-locked to the phase of the external AC line 161 and the DC power from the four-terminal PV module 120 can hence be efficiently provided to the load. In accordance with a preferred embodiment, the controller 130 receives the AC line signal S_L from the external AC line 161 and then based on the received AC line signal S_L, it generates a third control signal Sctrl_3 for controlling the DC/AC inverter 160 to match its AC output signal S_OA with the phase of the AC line signal S_L.

It is appreciated that although the power source is implemented as a single four-terminal photovoltaic module 120, in another example, the power source may be implemented as a plurality of four-terminal PV modules that are interconnected together to have only four output terminals that can provide the DC power as those of a single 4-terminal PV module.

Additionally, it is also appreciated that although the converter 110 in the above embodiment of FIG. 1 can be coupled with a four-terminal PV module, in another embodiment, a converter can be employed to convert output DC power of a three-terminal PV module.

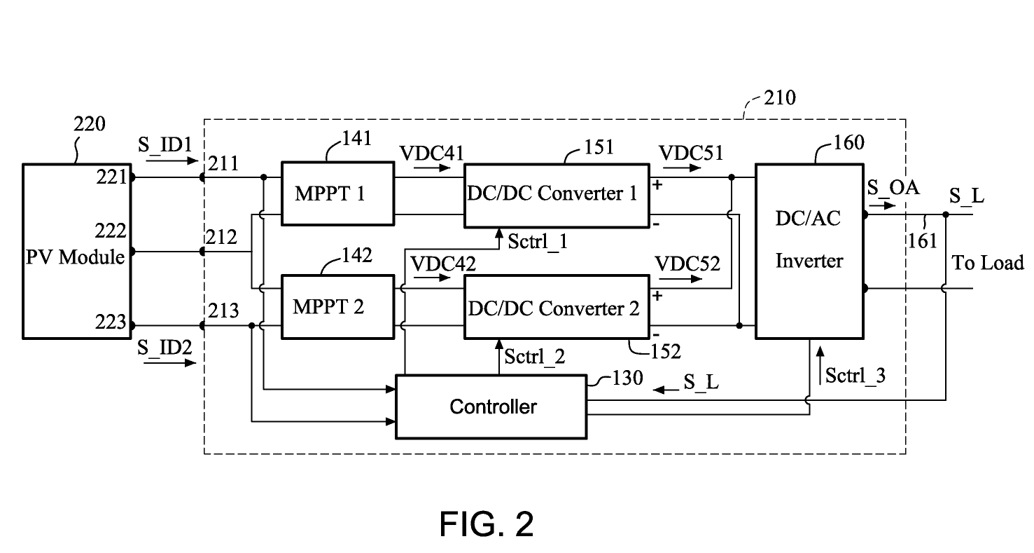

FIG. 2 is a schematic diagram illustrating the architecture of such a converter 210 in accordance with another embodiment, which can convert DC power, for example, from a three-terminal PV module 220, to AC power that can be fed to a load. The converter 210 differs from the converter 110 mainly in that it includes three input terminals 211, 212, and 213 rather than four input terminals, which can be coupled to three output terminals 221, 222, and 223 of the three-terminal PV module 220, respectively. As an example, the three input terminals 211˜213 of the converter 210 in the embodiment can be formed by connecting the respective common terminals of the two pairs of input electrodes in the converter 110. Detailed description of the converter 210 is similar to that of the converter 110 and thus omitted here for brevity.

A photovoltaic system can also be implemented for providing AC power for use by such as consumer appliances by employing the converter 110 of FIG. 1 or the converter 210 of FIG. 2. A photovoltaic system in accordance with a specific embodiment comprises one or more power sources (e.g. PV modules) for converting solar energy into DC power, and one or more converters for converting the DC power output from the one or more power sources to AC power for output from the photovoltaic system.

The PV module, in some embodiments, can be a three-terminal or four-terminal PV module. The PV module, for example, can include two photovoltaic devices that are integrated together, each having a respective pair of output terminals. One exemplary technology for forming the three-terminal or four-terminal PV module can be referred to in US Publication No. 2005/0150542, which provides three-terminal and four-terminal PV modules that are released from current-matching constrains and therefore more efficient and stable.

According to a specific embodiment, each of the converters can separately convert the respective DC power output from a corresponding one of the PV modules to AC power. Contrarily, according to another specific embodiment, one converter can convert the DC power output from a plurality of PV modules that are interconnected together to have three or four output terminals for providing the DC power.

The converter in each of the embodiments employs two DC/DC converters that can first “combine” two DC input signals by converting them to the same predetermined value, which can therefore be applied to a single DC/AC inverter for DC/AC conversion. As such, the converters in the embodiments can convert DC power for a three-terminal or four-terminal PV module without extra wirings for the extra one or two terminals of the PV module. Accordingly, the wiring between the converter in each of the embodiments and the three-terminal or four-terminal PV module can be as simple as the wiring between a conventional micro-inverter and a two-terminal PV module. In other words, the converters in the embodiments make a three-terminal or four-terminal PV module wired as a “virtual two-terminal PV module.” Consequently, the above embodiments can advantageously have lower system complexity and manufacturing costs compared to the conventional technologies utilizing three-terminal or four-terminal PV modules.

The converter in each of the above embodiments includes only two pairs of input electrodes. However, it can be appreciated that in other embodiments, the converter can be generalized to include more than two pairs of input electrodes.

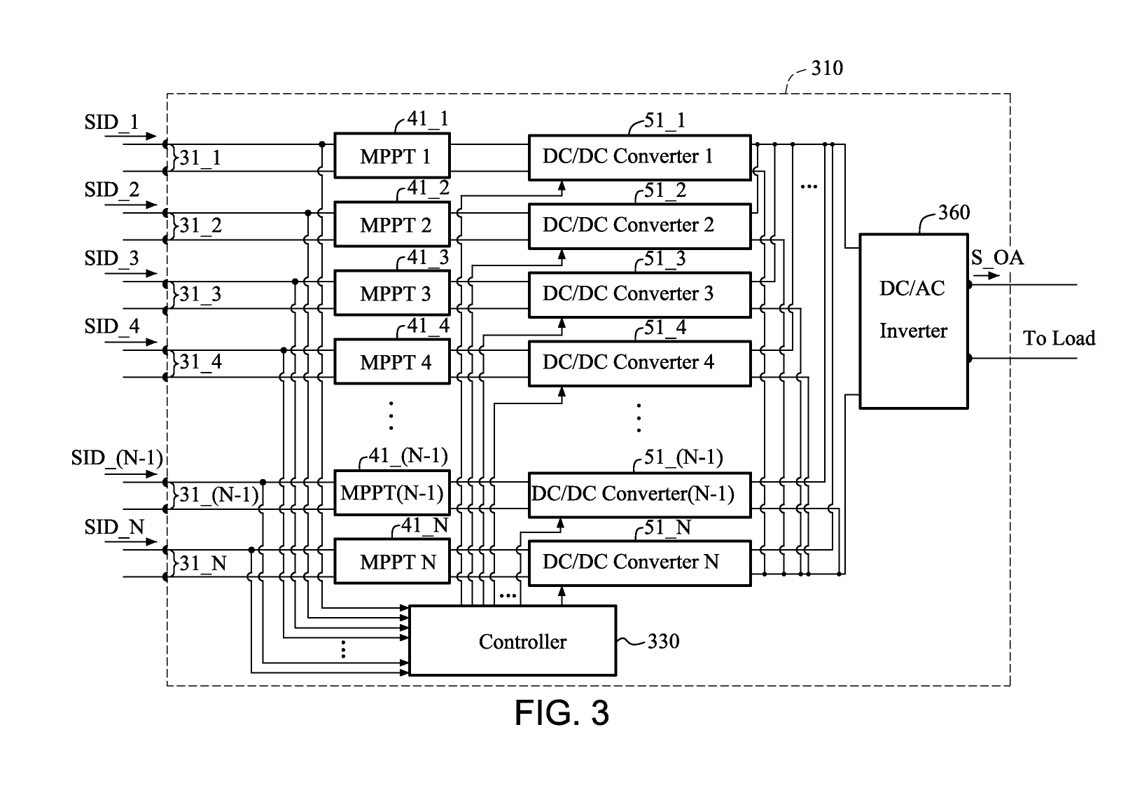

FIG. 3 is a schematic diagram illustrating the architecture of such a converter 310 in accordance with further another embodiment, wherein the converter 310 can convert DC power from a power source with multiple terminals (not shown).

The converter 310 differs from the converters 110 and 210 mainly in that it includes N pairs of (i.e., 2N) input electrodes 31_1˜31_N rather than 4 input electrodes. In other words, the converters 110 and 210 are specific cases where N=2.

Similar to the 2 pairs of input electrodes grouped as 4 input terminals to be coupled to the power source in the converter 110, the N pairs of input electrodes in the converter 310 can be grouped as 2N input terminals to receive 2N input signals SID_1˜SID_N from the power source, as shown in FIG. 3. However, in alternative embodiments similar to the 2 pairs of input electrodes grouped as 3 input terminals to be coupled to the power source in the converter 210, the N pairs of input electrodes can be connected as 2N−1 rather than 2N input terminals to be coupled to the power source.

The power source, for example, can include a single 2N-terminal PV module (N is an integer and N≧2) for providing the 2N input signals SID_1˜SID_N. Alternatively, the power source can include one or more 2N-terminal PV modules, or one or more (2N−1)-terminal PV modules, or a combination of them, for collectively providing the 2N input signals SID_1˜SID_N.

As shown in FIG. 3, the converter 310 can include N maximum power point trackers 41_1˜41_N. The maximum power point tracker 41_i (i is an integer and i=1˜N) can be coupled to the pair of input electrodes 31_i, configured to track a maximum power operation point for the DC power received from the pair of input electrodes 31_i.

Additionally, the converter 310 can include N pairs of DC/DC converters 51_1˜51_N. The DC/DC converter 51_i can be coupled to the maximum power point tracker 41_i, configured to convert a DC voltage received from the maximum power point tracker 41_i.

Additionally, the converter 310 can include a DC/AC inverter 360, coupled to the N DC/DC converters 51_1˜51_N. Namely, the N DC/DC converters 51_1˜51_N are parallel-connected to the DC/AC inverter 360. Thus, the DC/AC inverter 360 is configured to convert N DC voltages provided by the N DC/DC converters 51_1˜51_N into an AC output signal S_OA.

Additionally, the converter 310 can include a controller 330, coupled to the N DC/DC converters 51_1˜51_N and the DC/AC inverter 360, configured to control the DC/DC conversion operation of the N DC/DC converters 51_1˜51_N and the DC/AC conversion operation of the DC/AC inverter 360.

Further more, a photovoltaic system can also be implemented for providing AC power for use by consumer appliances by employing the converter 310 of FIG. 3. Detailed descriptions of the converter 310 and a photovoltaic system employing the same are similar to those of the converters 110 and 210 and thus omitted here for brevity.

While certain embodiments have been described above, it will be understood that the embodiments described are by way of example only. Accordingly, the device and methods described herein should not be limited to the described embodiments. Rather, the device and methods described herein should only be limited in light of the claims that follow when taken in conjunction with the above description and accompanying drawings.

What is claimed is:

1. A converting device with multiple input terminals and two output terminals for converting Direct Current (DC) power from a power source to Alternating Current (AC) power, comprising:
N pairs of input electrodes, configured to receive the DC power from the power source, where N is an integer and N≧2;
N maximum power point trackers, each coupled to one pair of the N pairs of input electrodes, configured to track a maximum power operation point for the DC power received from the one pair of the N pairs of input electrodes;
N pairs of DC/DC converters, each coupled to one of the N maximum power point trackers, configured to convert a DC voltage received from the one of the N maximum power point trackers;
a DC/AC inverter, coupled to the N DC/DC converters in parallel connection, configured to convert N DC voltages provided by the N DC/DC converters into an AC output signal; and
a controller, coupled to the N DC/DC converters and the DC/AC inverter, configured to control the DC/DC conversion operation of the N DC/DC converters and the DC/AC conversion operation of the DC/AC inverter.

2. The converting device with multiple input terminals and two output terminals of claim 1, wherein the N DC/DC converters convert the DC voltages from the N maximum power point trackers all into a predetermined value.

3. The converting device with multiple input terminals and two output terminals of claim 1, wherein the N pairs of input electrodes are grouped as 2N input terminals to be coupled to the power source.

4. The converting device with multiple input terminals and two output terminals of claim 1, wherein each two pairs of the N pairs of input electrodes are connected as three input terminals to be coupled to the power source.

5. The converting device with multiple input terminals and two output terminals of claim 1, wherein the controller determines respective voltage conversion ratios for the N DC/DC converters.

6. The converting device with multiple input terminals and two output terminals of claim 1, wherein the controller determines respective voltage conversion ratios for the N DC/DC converters according to input signals received from the N pairs of input electrodes and a predetermined value.

7. The converting device with multiple input terminals and two output terminals of claim 1, wherein the controller receives an AC line signal coupled to a load and based on the received AC line signal, the controller generates a control signal for controlling the DC/AC inverter to provide the AC output signal synchronous with the AC line signal.

8. A photovoltaic system, comprising:
one or more power sources for converting solar energy to DC power, each of the power sources having multiple terminals; and one or more converting devices with multiple input terminals and two output terminals for converting the DC power output from the one or more power sources into AC power for output from the photovoltaic system,
wherein each of the one or more converting devices comprises:
N pairs of input electrodes, configured to receive the DC power from the one ore more power sources, where N is an integer and N≧2;
N maximum power point trackers, each coupled to one pair of the N pairs of input electrodes, configured to track a maximum power operation point for the DC power received from the one pair of the N pairs of input electrodes;
N DC/DC converters, each coupled to one of the N maximum power point trackers, configured to convert a DC voltage received from the one of the N maximum power point trackers;
a DC/AC inverter, coupled to the N DC/DC converters, configured to convert N DC voltages provided by the N DC/DC converters to an AC output signal; and
a controller, configured to control the DC/DC conversion operation of the N DC/DC converters and the DC/AC conversion operation of the DC/AC inverter.

9. The photovoltaic system of claim 8, wherein the respective N DC/DC converters in each of the one or more converting devices convert the DC voltages from the N maximum power point trackers all into a predetermined value

10. The photovoltaic system of claim 8, wherein the respective N pairs of input electrodes in each of the one or more converting devices are grouped as N input terminals to be coupled to the one or more power sources.

11. The photovoltaic system of claim 8, wherein each two pairs of the respective N pairs of input electrodes in each of the one or more converting devices are connected as three input terminals to be coupled to the one or more power sources.

12. The photovoltaic system of claim 8, wherein each two pairs of the respective N pairs of input electrodes in each of the one or more converting devices are connected as three input terminals to be coupled to the one or more power sources.

13. The photovoltaic system of claim 8, wherein the respective controller in each of the one or more converting devices determines respective voltage conversion ratios for the N DC/DC converters.

14. The photovoltaic system of claim 8, wherein the respective controller in each of the one or more converting devices determines respective voltage conversion ratios for the N DC/DC converters according to input signals received from the N pairs of input electrodes and a predetermined value

15. The photovoltaic system of claim 8, wherein the respective controller in each of the one or more converting devices receives an AC line signal coupled to a load and based on the received AC line signal, the controller generates a control signal for controlling the DC/AC inverter to provide the AC output signal synchronous with the AC line signal.

16. A power converting method for converting Direct Current (DC) power to Alternating Current (AC) power, comprising:
tracking N maximum power operation points for the DC power and providing N first DC voltages, where N is an integer and N≧2;
converting the N first DC voltages to N second DC voltages, respectively; and
converting the N second DC voltages into an AC output signal.

17. The power converting method of claim 16, wherein the values of the N second voltages are all equal to a predetermined value.

18. The power converting method of claim 16, wherein the DC power is provided by a 2N-terminal photovoltaic module.

19. The power converting method of claim 16, further comprising determining voltage conversion ratios for the step of converting the two first DC voltages according to input signals serving the DC power and a predetermined value.

20. The power converting method of claim 16, further comprising generating a control signal according to an AC line signal, and the converting step of the two second DC voltages is realized according to the control signal to provide the AC output signal synchronous with the AC line signal.
